(19) United States
(12) Patent Application Publication
(10) Pub. No.: US 2018/0194896 A1
(43) Pub. Date: Jul. 12, 2018

(54) PRODUCTION OF A POLYAMIDE THAT CONTAINS 2,5-BIS(AMINOMETHYL)FURAN

(71) Applicant: BASF SE, Ludwigshafen (DE)

(72) Inventors: Gijsbrecht Jacobus Maria Habraken, Ludwigshafen (DE); Johannes Klaus Sprafke, Speyer (DE); Marion da Silva, Ludwigshafen (DE)

(21) Appl. No.: 15/740,012

(22) PCT Filed: Jul. 6, 2016
(86) PCT No.: PCT/EP2016/066029

§ 371 Date: Dec. 27, 2017

(30) Foreign Application Priority Data
Jul. 9, 2015 (EP) 15176125.1

(51) Int. Cl. C08G 69/16; C08G 69/26; C08G 69/28

(52) U.S. Cl. CPC C08G 69/16; C08G 69/28; C08G 69/265

(57) ABSTRACT

The present invention relates to a process for preparing a polyamide (P) by polymerization from a reaction mixture (RM), the reaction mixture (RM) comprising at least one lactam, at least one diamine (I), at least one dicarboxylic acid derivative, and water.

The present invention relates to a process for preparing a polyamide (P) by polymerization from a reaction mixture (RM), the reaction mixture (RM) comprising at least one lactam, at least one diamine (I), at least one dicarboxylic acid derivative, and water.

Polyamides in general are semicrystalline polymers which are of particular importance industrially on account of their very good mechanical properties. In particular they possess high strength, stiffness, and toughness, good chemical resistance, and a high abrasion resistance and tracking resistance. These properties are particularly important for the production of injection moldings. High toughness is particularly important for the use of polyamides as packaging films. On account of their mechanical properties, polyamides are used industrially for producing textiles such as fishing lines, climbing ropes, and carpeting. Polyamides also find use for the production of wall plugs, screws, and cable ties. Polyamides, furthermore, are employed as paints, adhesives, and coating materials.

In order to prepare polyamides which are particularly stable chemically and mechanically, polyamides are subjected, for example, to crosslinking. A disadvantage here, for example, is that crosslinked polyamides can no longer be processed, or can be processed only very poorly. Described in the prior art, therefore, are various processes for providing polymers, especially polyamides, which can be reversibly crosslinked in order to ensure their processability. Such polymers are also termed functional polymers.

For example, dienes and dienophiles can be incorporated into the side chains of polymers, these species being capable of joining adjacent chains to one another via

Diels-Alder reactions and so of crosslinking.

One dienophile used in the side groups of polymers in the prior art is maleimide, for example. One diene used in the side groups of polymers in the prior art is furan, for example.

One disadvantage of using dienes and dienophiles in the side chains of a polymer is that it is through the side chains that the mechanical properties of the polymer are modified. Moreover, the side chains raise the glass transition temperature, T_{G}, of the polymer and alter its crystallization behavior. Another problem with the use of dienes and dienophiles is seen as being that the dienes under certain circumstances enter into unwanted reactions with the dienophiles, as for example under shearing, as a result of which the properties of the polymer may alter.

There is therefore a need for processes which allow functional polymers to be produced, especially functional polyamides, which do not have the disadvantages described above, or have them to a reduced extent. One possibility for this is to incorporate diene structural units, such as furan, for example, into the main chain of a polymer. As and when necessary, the dienophile can be added to the polymer having the diene structural units in the main chain, and in this way the properties can be modified in a targeted way.

US 2014/0135449 describes a process for preparing polyamides containing furan units in the main chain, starting from dicarboxylic acids and 2,5-bis(aminomethyl)furan. According to US 2014/0135449, the preparation of the polyamides is a multistage operation, involving first contacting the dicarboxylic acid and the diamine with one another at a low temperature (40 to 80° C.) in water or methanol, to form a salt of the dicarboxylic acid and the diamine. Next the salt is treated in a stream of nitrogen, at a temperature just above the melting point of the salt, to form the polyamide. The melting point of the polyamide formed is well above the temperature at which the salt is treated.

With the process described in US 2014/0135449 it is already possible to prepare polyamides containing furan in the main chain. Nevertheless there is a need for further processes for preparing furan-containing polyamides that are less time-consuming than the process described in US 2014/0135449.

The object on which the present invention is based is therefore that of providing a further process for preparing polyamides containing furan in the main chain. The process is to be able to be carried out as simply and inexpensively as possible and is not to have the disadvantages described above, or to have them to a reduced extent.

This object is achieved by means of a process for preparing a polyamide (P) having a melting temperature T_{M} by polymerization from a reaction mixture (RM) at a reaction temperature T_{R}, wherein the reaction mixture (RM) comprises the following components:

(A) at least one lactam

(B) at least one diamine of the general formula (I)

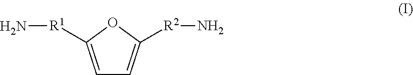

in which
R¹, R² independently of one another are selected from C₁-C₁₀ alkanediyl,
(C) at least one dicarboxylic acid derivative selected from the group consisting of a dicarboxylic acid of the general formula (II), a dicarboxylic ester of the general formula (III), and a dinitrile of the general formula (IV)

HOOC—R³—COOH (II)

R⁵OOC—R⁴—COOR⁶ (III)

NC—R⁷—CN (IV)
in which
R³, R⁴ and R⁷ independently of one another are selected from the group consisting of a bond, unsubstituted or at least monosubstituted C₁-C₄₀ alkanediyl, and unsubstituted or at least monosubstituted C₆-C₄₀ arylene, where
   the substituents are selected from the group consisting of F, Cl, Br, I, OR⁸, C₁-C₁₀ alkyl, and C₆-C₁₀ aryl, where
R⁸ is selected from the group consisting of H and C₁-C₁₀ alkyl;
R⁵ and R⁶ independently of one another are selected from the group consisting of unsubstituted or at least monosubstituted C₁-C₂₀ alkyl, unsubstituted or at least monosubstituted C₆-C₂₀ aryl, and unsubstituted or at least monosubstituted C₆-C₂₀ aralkyl, where
   the substituents are selected from the group consisting of F, Cl, Br, I, OR⁹, and C₁-C₁₀ alkyl, where
      R⁹ is selected from the group consisting of H and C₁-C₁₀ alkyl; and
(D) water.

A feature of the process of the invention is its ease of implementation. Surprisingly, the polyamides (P) prepared by the process of the invention possess a high weight-average molar mass (M_{w}) and a high number-average molar mass (Mₙ). Moreover, the polyamides (P) prepared in accordance with the invention have a particularly low polydispersity (M_{w}/Mₙ). The polyamides (P) prepared in accordance with the invention further possess a light inherent color.

The polyamides (P) prepared with the process of the invention may be further functionalized, moreover, by way of the furan groups present in the main chain. The furan groups also enable targeted crosslinking of the polyamides (P) in the invention. The polyamides (P) prepared in accordance with the invention may also be used as self-healing polymers.

The process of the invention is elucidated in more detail below.

Reaction Mixture (RM)

In accordance with the invention the reaction mixture (RM) comprises as component (A) at least one lactam, as component (B) at least one diamine (I), as component (C) at least one dicarboxylic acid derivative, selected from the group consisting of a dicarboxylic acid (II), a dicarboxylic ester (III), and a dinitrile (IV), as component (D) water, and optionally as component (E), from 0 to 1 wt % of at least one endgroup regulator, based on the total weight of components (A) to (E).

“At least one lactam” means in the context of the present invention not only exactly one lactam but also a mixture of two or more lactams.

“At least one diamine (I)” means in the context of the present invention not only exactly one diamine (I) but also a mixture of two or more diamines (I). The same applies to the term “at least one dicarboxylic acid derivative”. “At least one dicarboxylic acid derivative” means in the context of the present invention not only exactly one dicarboxylic acid derivative but also a mixture of two or more dicarboxylic acid derivatives.

“At least one endgroup regulator” means in the context of the present invention not only exactly one endgroup regulator but also a mixture of two or more endgroup regulators.

In one embodiment of the present invention the reaction mixture (RM) comprises as component (A) in the range from 26 to 98 wt % of at least one lactam, as component (B) in the range from 0.5 to 35 wt % of at least one diamine (I), as component (C) in the range from 0.5 to 30 wt % of at least one dicarboxylic acid derivative, as component (D) in the range from 1 to 30 wt % of water, and as component (E) in the range from 0 to 1 wt % of at least one endgroup regulator, the weight percentages being based in each case on the total weight of components (A) to (D) or based on the total weight of components (A) to (E) in the event that the reaction mixture (RM) includes the component (E).

In accordance with the invention the wt % figures of components (A), (B), (C), (D) and, optionally, of component (E) are based on the total weight of the components (A), (B), (C), (D) and, optionally, component (E) present in the reaction mixture (RM).

Where component (E) is not included in the reaction mixture (RM), the wt % figures of components (A), (B), (C) and (D) are based on the total weight of the components (A), (B), (C) and (D) present in the reaction mixture (RM).

In the event that component (E) is included in the reaction mixture (RM), the wt % figures of components (A), (B), (C), (D) and (E) are based on the total weight of the components (A), (B), (C), (D) and (E) present in the reaction mixture (RM).

In one preferred embodiment the wt % figures of components (A), (B), (C), (D) and, optionally, of component (E) are based on the total weight of the reaction mixture (RM).

In one embodiment of the present invention the reaction mixture (RM) therefore comprises

26 to 98 wt % of component (A),

0.5 to 35 wt % of component (B),

0.5 to 30 wt % of component (C) and

1 to 30 wt % of component (D),

the weight percentages being based in each case on the total weight of components (A) to (D) or based on the total weight of components (A) to (E), preferably based on the total weight of the reaction mixture (RM).

In a further, preferred embodiment the reaction mixture (RM) comprises as component (A) in the range from 50 to 89 wt % of at least one lactam, as component (B) in the range from 5 to 25 wt % of at least one diamine (I), as component (C) in the range from 5 to 25 wt % of at least one dicarboxylic acid derivative, as component (D) in the range from 1 to 20 wt % of water, and as component (E) in the range from 0.1 to 0.9 wt % of at least one endgroup regulator, the weight percentages being based in each case on the total weight of components (A) to (E), preferably based on the total weight of the reaction mixture (RM).

In one preferred embodiment of the present invention the reaction mixture (RM) therefore comprises

50 to 89 wt % of component (A),

5 to 25 wt % of component (B),

5 to 25 wt % of component (C),

1 to 20 wt % of component (D), and

0.1 to 0.9 wt % of component (E),

the weight percentages being based in each case on the total weight of components (A) to (E), preferably based on the total weight of the reaction mixture (RM).

In a further, particularly preferred embodiment the reaction mixture (RM) comprises as component (A) in the range from 75 to 82 wt % of at least one lactam, as component (B) in the range from 8 to 12 wt % of at least one diamine (I), as component (C) in the range from 11 to 13 wt % of at least one dicarboxylic acid derivative, as component (D) in the range from 1 to 5 wt % of water, and as component (E) in the range from 0.1 to 0.75 wt % of at least one endgroup regulator, the weight percentages being based in each case on the total weight of components (A) to (E), preferably based on the total weight of the reaction mixture (RM).

In one particularly preferred embodiment of the present invention the reaction mixture (RM) therefore comprises

75 to 82 wt % of component (A),

8 to 12 wt % of component (B),

11 to 13 wt % of component (C),

1 to 5 wt % of component (D), and

0.1 to 0.75 wt % of component (E),

the weight percentages being based in each case on the total weight of components (A) to (E), preferably based on the total weight of the reaction mixture (RM).

The present invention accordingly also provides a process wherein the reaction mixture (RM) comprises

26 to 98 wt % of component (A),

0.5 to 35 wt % of component (B),

0.5 to 30 wt % of component (C),

1 to 30 wt % of component (D), and

0 to 1 wt % of component (E)

based on the total weight of components (A) to (E), preferably based on the total weight of the reaction mixture (RM).

The sum of the weight percentages of the components (A) to (E) adds up in general to 100 wt %.

Unless otherwise indicated, all of the weight percent figures of components (A) to (E) are based on the composition of the reaction mixture (RM) at the beginning of the polymerization. The phrase “composition of the reaction mixture (RM) at the beginning of the polymerization” refers in the context of the present invention to the composition of the reaction mixture (RM) before the components (A) to (E) present in the reaction mixture (RM) begin to react with one another, in other words before the polymerization sets in. The components (A) to (E) present in the reaction mixture (RM) are at that point therefore still in their unreacted form. It is self-evident that during the polymerization the components (A) to (E) present in the reaction mixture (RM) react at least partly with one another and therefore that the proportions of the components (A) to (E) among one another change, just as the components (A) to (E) present in the reaction mixture (RM) change during the polymerization. The skilled person is aware of these reactions.

In the text below, the individual components of the reaction mixture (RM) are elucidated in more detail.

Component (A): Lactam

In one embodiment the reaction mixture (RM) comprises as component (A) in the range from 26 to 98 wt % of at least one lactam, preferably in the range from 50 to 89 wt %, and especially preferably in the range from 75 to 82 wt %, based in each case on the total weight of components (A) to (D) or based on the total weight of components (A) to (E), preferably based on the total weight of the reaction mixture (RM).

In one embodiment of the present invention, therefore, the reaction mixture (RM) comprises in the range from 26 to 98 wt % of component (A), preferably in the range from 50 to 89 wt % of component (A), and especially preferably in the range from 75 to 82 wt % of component (A), the weight percentages being based in each case on the total weight of components (A) to (D) or based on the total weight of components (A) to (E), preferably based on the total weight of the reaction mixture (RM).

The present invention accordingly also provides a process wherein the reaction mixture (RM) comprises as component (A) in the range from 26 to 98 wt % of at least one lactam, based on the total weight of components (A) to (D) or based on the total weight of components (A) to (E), preferably based on the total weight of the reaction mixture (RM).

Lactam in accordance with the invention refers to cyclic amides which have 3 to 12 carbon atoms in the ring, preferably 6 to 12 carbon atoms. Suitable lactams are for example selected from the group consisting of 3-aminopropanolactam (β-lactam; β-propiolactam), 4-aminobutanolactam (γ-lactam; γ-butyrolactam), 5-amino-pentanolactam (δ-lactam; δ-valerolactam), 6-aminohexanolactam (ε-lactam; ε-caprolactam), 7-aminoheptanolactam (ζ-lactam; ζ-heptanolactam), 8-aminooctanolactam (η-lactam; η-octanolactam), 9-nonanolactam (θ-lactam; θ-nonanolactam), 10-decanolactam (ω-decanolactam), 11-undecanolactam (ω-undecanolactam), and 12-dodecanolactam (ω-dodecanolactam).

The lactams may be unsubstituted or at least monosubstituted. Where at least monosubstituted lactams are used, they may carry, on the carbon atoms of the ring, one, two or more substituents which are selected independently of one another from the group consisting of C₁ to C₁₀ alkyl, C₅ to C₆ cycloalkyl and C₅ to C₁₀ aryl.

Suitability as C₁ to C₁₀ alkyl substituents is possessed for example by methyl, ethyl, propyl, isopropyl, n-butyl, sec-butyl, and tert-butyl. An example of a suitable C₅ to C₆ cycloalkyl substituent is cyclohexyl. Preferred C₅ to C₁₀ aryl substituents are phenyl and anthranyl.

Preference is given to using unsubstituted lactams, in which case 12-dodecanolactam (ω-dodecanolactam) and ε-lactam (ε-caprolactam) are preferred. Particularly preferred is ε-lactam (ε-caprolactam).

ε-Caprolactam is the cyclic amide of caproic acid. It is also referred to as 6-aminohexanolactam, 6-hexanolactam or caprolactam. Its IUPAC name is “acepan-2-one”. Caprolactam possesses the CAS number 105-60-2 and the general formula C₆H₁₁NO. Processes for preparing caprolactam are known per se to the skilled person.

Component (B): Diamine (I)

In one embodiment of the invention the reaction mixture (RM) comprises as component (B) in the range from 0.5 to 35 wt % of at least one diamine (I), preferably in the range from 5 to 25 wt %, and especially preferably in the range from 8 to 12 wt %, based in each case on the total weight of components (A) to (D) or based on the total weight of components (A) to (E), preferably based on the total weight of the reaction mixture (RM).

In one embodiment of the present invention, therefore, the reaction mixture (RM) comprises in the range from 0.5 to 35 wt % of component (B), preferably in the range from 5 to 25 wt % of component (B), and especially preferably in the range from 8 to 12 wt % of component (B), the weight percentages being based in each case on the total weight of components (A) to (D) or based on the total weight of components (A) to (E), preferably based on the total weight of the reaction mixture (RM).

Component (B) in accordance with the invention is at least one diamine (I)

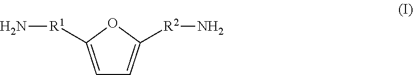

in which R¹ and R² have the definitions described above.

In one preferred embodiment component (B) is at least one diamine (I) in which R¹ and R² are selected independently of one another from C₁-C₄ alkanediyl.

In one particularly preferred embodiment component (B) is at least one diamine (I) in which R¹ and R² are the same C₁-C₄ alkanediyl.

In one especially preferred embodiment component (B) is at least one diamine (I) in which R¹ and R² are both methylene.

If R¹ and R² are both methylene, the diamine (I) is 2,5-bis(aminomethyl)furan. 2,5-Bis(aminomethyl)furan has the CAS number 2213-51-6.

Processes for preparing 2,5-bis(aminomethyl)furan are known per se to the skilled person.

“C₁-C₁₀ alkanediyl” as described for example above for R¹ and R² for the diamine (I) means in the context of the present invention a hydrocarbon having 1 to 10 carbon atoms and two free valences. It is therefore a biradical having 1 to 10 carbon atoms. “C₁-C₁₀ alkanediyl” encompasses both linear and cyclic, and also saturated and unsaturated, hydrocarbons having 1 to 10 carbon atoms and two free valences. Hydrocarbons having a cyclic fraction and a linear fraction are likewise included by the term “C₁-C₁₀ alkanediyl”. Examples of C₁-C₁₀ alkanediyls are methylene, ethylene (ethane-1,2-diyl, dimethylene), propane-1,3-diyl (trimethylene), propylene (propane-1,2-diyl), and butane-1,4-diyl (tetramethylene). Corresponding observations apply in respect of “C₁-C₄ alkanediyl”.

In one embodiment, moreover, the reaction mixture (RM) may further comprise at least one further diamine (component (B′)).

The present invention accordingly also provides a process wherein the reaction mixture (RM) further comprises component (B′), at least one further diamine.

In one embodiment of the invention the reaction mixture (RM) comprises as component (B′) in the range from 0 to 34.5 wt % of at least one further diamine, preferably in the range from 1 to 19.5 wt %, and especially preferably in the range from 1 to 10 wt %, based in each case on the total weight of components (A), (B), (B′), (C), (D), and (E).

In one embodiment of the present invention the reaction mixture (RM) therefore comprises in the range from 0.5 to 34.5 wt % of component (B′), preferably in the range from 1 to 19.5 wt % of component (B′), and especially preferably in the range from 1 to 10 wt % of component (B′), the weight percentages being based in each case on the total weight of components (A), (B), (B′), (C), (D), and (E).

Suitable further diamines (component (B′)) are known per se to the skilled person. It is self-evident that the at least one further diamine (component (B′)) is different from component (B), the diamine (I). The at least one further diamine is preferably selected from alkanediamines having 4 to 36 carbon atoms, more particularly alkanediamines having 6 to 12 carbon atoms, and also aromatic diamines. With particular preference the at least one further diamine is selected from the group consisting of 1,4-butane-diamine, 1,5-pentanediamine, 1,6-hexamethylenediamine, 1,7-heptamethylenediamine, 1,8-octamethylenediamine, 1,9-nonanediamine, 1,10-decanediamine, 1,11-undecane-diamine, 1,12-dodecanediamine, 1,13-tridecanediamine, 1,14-tetradecanediamine, 1,15-pentadecanediamine, 1,16-hexadecanediamine, 1,17-heptadecanediamine, 1,18-octadecanediamine, C36-dimer diamine, bis(4-amino-3-methylcyclohexyl)methane (MACM), 4,4-methylenebis(cyclohexylamine) (PACM), bis(4-amino-3-ethyl-cyclohexyl)methane (EACM), bis(4-amino-3,5-dimethylcyclohexyl)methane (TMACM), isophoronediamine, m-xylylenediamine, p-xylylenediamine, 2,5-bis(methylamino)-tetrahydrofuran, 2,2-di(4-aminophenyl)propane, 2,2-di(4-aminocyclohexyl)propane, 2,4,4-trimethylhexamethylenediamine, and 1,5-diamino-2-methylpentane.

Component (C): Dicarboxylic Acid Derivative

In one embodiment of the invention the reaction mixture (RM) comprises as component (C) in the range from 0.5 to 30 wt % of at least one dicarboxylic acid derivative, preferably in the range from 5 to 25 wt %, and especially preferably in the range from 11 to 13 wt %, based in each case on the total weight of components (A) to (D) or based on the total weight of components (A) to (E), preferably based on the total weight of the reaction mixture (RM).

In one embodiment of the present invention the reaction mixture (RM) therefore comprises in the range from 0.5 to 30 wt % of component (C), preferably in the range from 5 to 25 wt % of component (C), and especially preferably in the range from 11 to 13 wt % of component (C), the weight percentages being based in each case on the total weight of components (A) to (D) or based on the total weight of components (A) to (E), preferably based on the total weight of the reaction mixture (RM).

The at least one dicarboxylic acid derivative is selected in accordance with the invention from the group consisting of a dicarboxylic acid of the general formula (II), a dicarboxylic ester of the general formula (III), and a dinitrile of the general formula (IV)

HOOC—R³—COOH (II)

R⁵OOC—R⁴—COOR⁶ (III)

NC—R⁷—CN (IV)

in which

R³, R⁴, R⁵, R⁶, and R⁷ have the definitions stated above.

In one preferred embodiment the substituents in the formula (II), the formula (III), and the formula (IV) have the following definitions:

R³, R⁴ and R⁷ are selected independently of one another from the group consisting of a bond, C₁-C₃₆ alkanediyl, and C₆-C₂₀ arylene;

R⁵ and R⁶ are selected independently of one another from the group consisting of C₁-C₁₀ alkyl, C₆-C₁₀ aryl, and C₆-C₁₂ aralkyl.

In one especially preferred embodiment the substituents in the formula (II), the formula (III), and the formula (IV) have the following definitions:

R³, R⁴ and R⁷ are selected independently of one another from the group consisting of a bond, C₁-C₁₂ alkanediyl, and C₆-C₁₀ arylene;

R⁵ and R⁶ are selected independently of one another from the group consisting of C₁-C₄ alkyl, C₁-C₁₀ aryl, and C₁-C₁₂ aralkyl. “C₁-C₄₀ alkanediyl”, as described for R³ in formula (II), for example, is understood in the context of the present invention to refer to a hydrocarbon having two free valences and from 1 to 40 carbon atoms. Expressed otherwise, a C₁-C₄₀ alkanediyl is a biradical having 1 to 40 carbon atoms. “C₁-C₄₀ alkanediyl” encompasses both linear and cyclic, and also saturated and unsaturated, hydrocarbons having 1 to 40 carbon atoms and two free valences. Hydrocarbons which have both a linear and a cyclic component are likewise covered by the term. Corresponding statements apply in respect of C₁-C₃₆ alkanediyl and C₁-C₁₂ alkanediyl.

“C₆-C₄₀ arylene” refers to an aromatic hydrocarbon having two free valences and from 6 to 40 carbon atoms. Expressed otherwise, “C₆-C₄₀ arylene” refers to an aromatic biradical having 6 to 40 carbon atoms. A C₆-C₄₀ arylene therefore has an aromatic ring system. This ring system may be monocyclic, bicyclic or polycyclic. Corresponding statements apply in respect of C₆-C₂₀ arylene and C₆-C₁₀ arylene.

“C₁-C₂₀ alkyl” refers to saturated and unsaturated hydrocarbons having one free valence (radical) and from 1 to 20 carbon atoms. The hydrocarbons may be linear, branched or cyclic. It is also possible for them to comprise a cyclic component and a linear component. Examples of alkyl groups are methyl, ethyl, n-propyl, isopropyl, n-butyl, isobutyl, sec-butyl, tert-butyl, hexyl, and cyclohexyl. Corresponding statements also apply in respect of C₁-C₁₀ alkyl.

“C₆-C₂₀ aryl” denotes the radical of an aromatic hydrocarbon having 6 to 20 carbon atoms. An aryl therefore has an aromatic ring system. This ring system may be monocyclic, bicyclic or polycyclic. Examples of aryl groups are phenyl and naphthyl such as 1 -naphthyl and 2-naphthyl, for example.

“C₆-C₂₀ aralkyl” denotes in the present context that the substituent is an alkyl which in turn is substituted by an aryl. Expressed otherwise, aralkyl describes an alkanediyl which is substituted by an aryl radical. A C₆-C₂₀ aralkyl is an aralkyl which contains 6 to 20 carbon atoms. The aryl radical may for example be an aryl as defined above. Examples of aralkyl are phenylmethyl (benzyl) or phenylethyl, for example.

In a further preferred embodiment, the at least one dicarboxylic acid derivative is selected from the group consisting of a dicarboxylic acid of the general formula (II) and a dicarboxylic ester of the general formula (III).

The dicarboxylic acid (II) and the dicarboxylic ester (III) are subject to the statements and preferences described above.

In a further preferred embodiment component (C) comprises a dicarboxylic acid (II) as the at least one dicarboxylic acid derivative. The at least one dicarboxylic acid derivative preferably comprises in the range from 0 to 30 wt % of a dicarboxylic acid (II), more preferably in the range from 0.5 to 29.5 wt % of a dicarboxylic acid (II), and especially preferably in the range from 1 to 12 wt % of a dicarboxylic acid (II), based on the total weight of the at least one dicarboxylic acid derivative. In a most preferred embodiment the at least one dicarboxylic acid derivative consists of a dicarboxylic acid (II).

Expressed in a different way, in a further preferred embodiment, component (C) comprises a dicarboxylic acid (II). Preferably component (C) comprises in the range from 0 to 30 wt % of a dicarboxylic acid (II), more preferably in the range from 0.5 to 29.5 wt % of a dicarboxylic acid (II), and especially preferably in the range from 1 to 12 wt % of a dicarboxylic acid (II), based on the total weight of component (C). In a most preferred embodiment component (C) consists of a dicarboxylic acid (II).

The present invention accordingly also provides a process wherein the reaction mixture (RM) comprises a dicarboxylic acid (II) as the at least one dicarboxylic acid derivative (component (C)).

In another preferred embodiment the dicarboxylic acid (II) is selected from the group consisting of oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), sebacic acid (decanedioic acid), 1,11-undecanedioic acid, 1,12-dodecanedioic acid, 1,13-tridecanedioic acid, 1,14-tetradecanedioic acid, 1,15-pentadecanedioic acid, 1,16-hexadecanedioic acid, 1,17-heptadecanedioic acid, 1,18-octadecanedioic acid, 1,3-cyclohexanedicarboxylic acid, 1,4-cyclohexanedicarboxylic acid, isophthalic acid, terephthalic acid, naphthalenedicarboxylic acid, C36-dimer acid, 2,5-tetrahydrofurandicarboxylic acid, 2,5-furandicarboxylic acid, monosodium 5-sulfo-isophthalate, and monolithium 5-sulfoisophthalate.

In a further, especially preferred embodiment, the dicarboxylic acid is selected from the group consisting of adipic acid (hexanedioic acid), pimelic acid (heptanedioic acid), suberic acid (octanedioic acid), azelaic acid (nonanedioic acid), sebacic acid (decanedioic acid), 1,11-undecanedioic acid, 1,12-dodecanedioic acid, 1,13-tridecane-dioic acid, 1,14-tetradecanedioic acid, 1,15-pentadecanedioic acid, 1,16-hexa-decanedioic acid, 1,17-heptadecanedioic acid, 1,18-octadecanedioic acid, 2,5-tetra-hydrofurandicarboxylic acid, 1,3-cyclohexanedicarboxylic acid, 1,4-cyclohexane-dicarboxylic acid, isophthalic acid, terephthalic acid, naphthalenedicarboxylic acid, and C36-dimer acid.

Component (D): Water

In one embodiment of the invention the reaction mixture (RM) comprises as component (D) in the range from 1 to 30 wt % of water, preferably in the range from 1 to 20 wt %, and especially preferably in the range from 1 to 5 wt %, based in each case on the total weight of components (A) to (D) or based on the total weight of components (A) to (E), preferably based on the total weight of the reaction mixture (RM).

In one embodiment of the present invention the reaction mixture (RM) therefore comprises in the range from 1 to 30 wt % of component (D), preferably in the range from 1 to 20 wt % of component (D), and especially preferably in the range from 1 to 5 wt % of component (D), the weight percentages being based in each case on the total weight of components (A) to (D) or based on the total weight of components (A) to (E), preferably based on the total weight of the reaction mixture (RM).

Accordingly the present invention also provides a process wherein the reaction mixture (RM) comprises as component (D) in the range from 1 to 30 wt % of water, based on the total weight of components (A) to (E).

Used preferably as component (D) is deionized and/or distilled water.

Component (E): Endgroup Regulator

In one embodiment of the invention the reaction mixture (RM) comprises as component (E) in the range from 0 to 1 wt % of chain regulator, preferably in the range from 0.1 to 0.9 wt % and especially preferably in the range from 0.1 to 0.75 wt %, based in each case on the total weight of components (A) to (E).

In one embodiment of the present invention the reaction mixture (RM) therefore comprises in the range from 0 to 1 wt % of component (E), preferably in the range from 0.1 to 0.9 wt % of component (E), and especially preferably in the range from 0.1 to 0.75 wt % of component (E), the weight percentages being based in each case on the total weight of components (A) to (E).

The present invention accordingly also provides a process wherein the reaction mixture (RM) comprises as component (E) 0.1 to 0.9 wt % of at least one endgroup regulator, based on the total weight of components (A) to (E).

Suitable endgroup regulators are known per se to the skilled person. Examples of suitable endgroup regulators are monocarboxylic acids, monoamines, benzene-monocarboxylic acids, naphthalenemonocarboxylic acids, benzenemonoamines, naphthalenemonoamines, or diacids or anhydrides which form imides with amines.

Preferred endgroup regulators are, for example, C₁-C₁₀ alkanemonocarboxylic acids, C₅-C₈ cycloalkanemonocarboxylic acids, benzenemonocarboxylic acids, naphthalene-monocarboxylic acids, C₁-C₁₀ alkanemonoamines, C₅-C₈ cycloalkanemonoamines, benzenemonoamines, naphthalenemonoamines, or diacids or anhydrides which form imides with amines. Particularly preferred endgroup regulators are selected for example from the group consisting of acetic acid, propionic acid, cyclopentanecarboxylic acid, cyclohexanecarboxylic acid, benzoic acid, naphthalenecarboxylic acid, cyclopentanamine, cyclohexanamine, 4-amino-2,2,6,6-tetramethylpiperidine (TAD), aniline, naphthalenamine, succinic acid, and succinic anhydride.

Polyamide (P)

The polyamide (P) obtained in accordance with the invention comprises structural units derived from the at least one lactam (component (A)), structural units derived from the at least one diamine (I) (component (B)), and structural units derived from the at least one dicarboxylic acid derivative (component (C)).

The polyamide (P) preferably comprises in the range from 26 to 98 wt % of structural units derived from the at least one lactam (component (A)), more preferably in the range from 50 to 98 wt %, and especially preferably in the range from 78 to 98 wt %, based in each case on the total weight of the polyamide (P).

The polyamide (P) prepared in accordance with the invention generally has a viscosity number in the range from 60 to 250 ml/g, preferably from 90 to 220 ml/g, and especially preferably in the range from 100 to 130 ml/g. The viscosity number is determined in a solution of 0.5 g of polyamide (P) in 100 ml of a 1:1 mixture of phenol and o-dichlorobenzene.

The weight-average molecular weight (M_{w}) for the polyamide (P) prepared in accordance with the invention is in the range from 20 000 to 150 000 g/mol, preferably in the range from 30 000 to 140 000 g/mol, and more particularly in the range from 35 000 to 120 000 g/mol, determined by means of gel permeation chromatography (GPC) (size exclusion chromatography (SEC)). Solvent used was hexafluoroisopropanol (HFIP).

The number-average molecular weight (Mᵣ) is customarily in the range from 5000 to 75 000 g/mol for the polyamide (P) prepared in accordance with the invention, preferably in the range from 15 000 to 70 000 g/mol, and especially preferably in the range from 17 500 to 60 000 g/mol, determined by means of gel permeation chromatography (GPC) (size exclusion chromatography (SEC)). Solvent used was hexafluoroisopropanol (HFIP).

The ratio of the weight-average molecular weight (M_{w}) to the number-average molecular weight (Mᵣ) is referred to as “polydispersity” (PDI; M_{w}/Mₙ). The polydispersity of the polyamide (P) prepared in accordance with the invention is preferably in the range from 2.0 to 4.0, more preferably in the range from 2.0 to 3.5, and especially preferably in the range from 2.0 to 3.0.

The melting temperature T_{M} of the polyamide (P) prepared in accordance with the invention is preferably in the range from 80 to 230° C., more preferably in the range from 150 to 220° C., and most preferably in the range from 175 to 220° C., determined by differential scanning calorimetry (DSC) or by dynamic mechanical thermoanalysis (DMTA).

The present invention accordingly also provides a process wherein the melting temperature T_{M} of the polyamide (P) is in the range from 80 to 230° C.

The enthalpy of fusion ΔH of the polyamide (P) prepared in accordance with the invention is preferably in the range from 0 to 120 J/g, more preferably in the range from 1 to 80 J/g, and most preferably in the range from 2 to 70 J/g, determined by DSC.

The glass transition temperature T_{G} of the dry polyamide (P) is generally in the range from 0 to 85° C., preferably in the range from 40 to 84° C., and especially preferably in the range from 50 to 80° C., determined by DSC.

Polymerization

The polymerization of the reaction mixture (RM) may be carried out in any reactors which can be pressurized. Examples of suitable such reactors are autoclaves, continuous reactors or batch reactors.

In one embodiment the reactors in which the polymerization of the reaction mixture (RM) takes place receive a mixing apparatus. In a further embodiment, the components present in the reaction mixture (RM) are mixed by suitable mixing apparatus prior to entry into the reactor. Suitable mixing apparatus as such is known to the skilled person.

The mixing apparatus may be either static or dynamic. Examples of static mixing apparatus are static mixers. Examples of dynamic mixing apparatus are stirrers. Suitable stirrers are all stirrers known to the skilled person. Preferred stirrers are anchor stirrers.

In one particularly preferred embodiment of the present invention, then, the reaction mixture (RM) is stirred during the polymerization.

The present invention accordingly also provides a process wherein the reaction mixture (RM) is stirred during the polymerization.

In one embodiment the reaction mixture (RM) is heated so that it is in liquid form in order to mix the components. The reaction mixture (RM) is preferably transported in the liquid state to the reactor.

The polymerization of the reaction mixture (RM) takes place in accordance with the invention at a reaction temperature T_{R}. The reaction temperature T_{R} is preferably above the melting temperature T_{M} of the polyamide (P).

The present invention accordingly also provides a process wherein the reaction temperature T_{R} is above the melting temperature T_{M} of the polyamide (P).

The reaction temperature T_{R} is generally at least 5° C. above the melting temperature T_{M} of the polyamide (P), preferably at least 10° C. above the melting temperature T_{M} of the polyamide (P), and especially preferably at least 20° C. above the melting temperature T_{M} of the polyamide (P).

The reaction temperature T_{R} is preferably below 250° C., more preferably below 235° C., and especially preferably below 220° C.

In a further preferred embodiment, the reaction temperature T_{R} is in the range from 190 to 235° C., preferably in the range from 195 to 230° C., and especially preferably in the range from 200 to 220° C.

The present invention accordingly also provides a process wherein the reaction temperature T_{R} is in the range from 190 to 235° C.

In one embodiment of the present invention the polymerization is carried out at a pressure p in the range from 1 to 25 bar, preferably in the range from 3 to 22 bar, and especially preferably in the range from 5 to 20 bar.

The pressure may be regulated for example via the fraction of component (D), water, in the reaction mixture (RM), and via the reaction temperature T_{R}. At the reaction temperature T_{R} used, component (D), the water, undergoes transition at least partly into the gas phase, and so raises the pressure p in the reactor.

In one preferred embodiment of the present invention the polymerization of the reaction mixture (RM) is carried out in a plurality of steps. In one embodiment the polymerization comprises the following steps.
a) heating the reaction mixture (RM) to the reaction temperature T_{R} and establishing a first pressure pₐ,
b) lowering the first pressure pₐ to a second pressure p_{b} below the first pressure pₐ, the reaction temperature T_{R} from process step a) being retained.

The present invention accordingly also provides a process wherein the polymerization of the reaction mixture (RM) comprises the following steps:
a) heating the reaction mixture (RM) to a reaction temperature T_{R} and establishing a first pressure pₐ,
b) lowering the first pressure pₐ to a second pressure p_{b} below the first pressure pₐ, the reaction temperature T_{R} from process step a) being retained.

In process step a) the reaction mixture (RM) is heated to a reaction temperature T_{R}. Methods for heating the reaction mixture (RM) are known per se to the skilled person. In this step, at least part of the component (D), water, present in the reaction mixture (RM) evaporates and so raises the pressure in the reactor.

In one embodiment of the present invention in process step a) a first pressure pₐ in the range from 1 to 25 bar is established, preferably in the range from 2 to 20 bar, and especially preferably in the range from 3 to 10 bar.

The present invention accordingly also provides a process wherein the first pressure pₐ in process step a) is in the range from 1 to 25 bar.

Process step a) and also the preferred subsequent holding of the first pressure pₐ is also referred to as “pressure phase”. The idea is that during this pressure phase, the ring of the at least one lactam (component (A)) present in the reaction mixture (RM) is opened, to form the corresponding aminocarboxylic acid and also oligomers thereof.

In process step b) the first pressure pₐ is lowered to a second pressure p_{b}. The second pressure p_{b} is preferably in the range from 0.5 to 1.5 bar, more preferably in the range from 0.7 to 1.3 bar, and especially preferably in the range from 0.9 to 1.1 bar.

The present invention accordingly also provides a process wherein the second pressure p_{b} in process step b) is in the range from 0.5 to 1.5 bar.

The lowering of the first pressure pₐ to the second pressure p_{b} takes place in general by the distillative removal of component (D), the water. Methods for this are known per se to the skilled person.

“Retaining the reaction temperature T_{R} from process step a)” means in the present context that the reaction temperature T_{R} in process step b) changes relative to the reaction temperature T_{R} in process step a) by at most +/−5° C., preferably by at most +/−2° C. and especially preferably by at most +/−1° C.

The idea is that during the lowering of the first pressure pₐ to the second pressure P_{b}, components (A), (B), and (C) which are present in the reaction mixture (RM) undergo condensation with one another and so polymerize, to give, in particular, polyamides (P) of low molecular weight.

A by-product formed in this condensation is water. This water is customarily also removed by distillation to achieve a lowering of the first pressure pₐ to the second pressure p_{b}.

In one embodiment of the invention process step b) is followed by the following process step:
c) holding the second pressure p_{b} and the reaction temperature T_{R} from process step b) for a period in the range from 20 min to 20 h.

The present invention accordingly also provides a process wherein step b) is followed by the following step:
c) holding the second pressure p_{b} and the reaction temperature T_{R} from process step b) for a period in the range from 20 minutes to 20 hours.

“Holding the second pressure p_{b}” means in the present context that the second pressure p_{b} in process step c) changes relative to the second pressure p_{b} in process step b) by at most +/−0.5 bar, preferably by at most +/−0.2 bar and especially preferably by at most +/−0.05 bar.

“Holding the reaction temperature T_{R} from process step b)” means in the present context that the reaction temperature T_{R} in process step c) changes relative to the reaction temperature T_{R} in process step b) by at most +/−5° C., preferably by at most +/−2° C. and especially preferably by at most +/−1° C.

In one preferred embodiment the second pressure p_{b} and the reaction temperature T_{R} in process step c) are held for a period in the range from 30 min to 15 h, more preferably in the range from 50 min to 10 h.

The idea is that in process step c) there is an aftercondensation of the polyamide formed in process step b), during which the molecular weight of the polyamide (P) goes up. Water is formed in the condensation.

In a further preferred embodiment of the present invention, water formed in process step c) as well is removed continuously from the reaction mixture (RM) and hence the second pressure p_{b} is held in a range from 0.001 to 1.5 bar, preferably in the range from 0.7 to 1.3 bar, and especially preferably in the range from 0.9 to 1.1 bar.

In one embodiment of the invention the polyamide (P), following its preparation, is removed in melted form from the reactor. The melted polyamide (P) may then be cooled, for example, in a waterbath and pelletized. The lactam present in the polyamide (P) can then be extracted from the pellets using water.

Methods for this are known to the skilled person.

Following the extraction of the lactam from the pellets, the polyamide (P) present in the pellets may be polymerized further. Methods for this are known to the skilled person. The polyamide (P) is preferably polymerized further by a solid-phase condensation, in order to obtain higher molecular weights. Methods for this are known to the skilled person. For example, the pellets may be treated in the presence of hot inert gas, as for example nitrogen, at a temperature below the melting temperature of the polyamide (P). The temperature is preferably in the range from 5 to 40° C. below the melting temperature of the polyamide (P).

Since the polymerization of the reaction mixture (RM) is carried out at a reaction temperature T_{R} which is above the melting temperature T_{M} of the polyamide (P), the polyamide (P) is obtained in melted form. This makes it possible, for example, for the polyamide (P) to be pelletized directly from the reactor. There is therefore no need for an interim step in which the polyamide (P) has to be melted in order for it to be subsequently pelletized. This makes the process of the invention particularly favorable in terms of time and cost.

### EXAMPLES

Components used in the examples were as follows:

(A-1) caprolactam

(B-1) 2,5-bis(aminomethyl)furan

(B′-1) hexamethylenediamine (HMD), purity: 99.9%

(B′-2) 4,4-methylenebis(cyclohexylamine), purity: 99%

(C-1) adipic acid, purity: 99.9%

(C-2) sebacic acid, purity: >99%

(C-3) C36-dimer acid, with CAS number 61788-89-4, high purity: 95-99.0% dimer acid, <2.5% trimer acid, <3% monoacid

(B′-C′) salt of hexamethylenediamine (HMD) and adipic acid (1:1)

(D) deionized water

(D′) isopropanol

To prepare the polyamide (P) components (A) to (D) described above were mixed with one another, in the quantities stated in Table 1 in a 1.2 liter Büchi reactor. The reaction mixture (RM) of Examples 17 to 21, 22, 23, V24, 25 and 26 was stirred throughout the reaction. Examples 17 to 21, 23, 25 and 26 are inventive examples; Examples V22 and V24 are comparative examples.

According to process step a), the external temperature T_{A} and the reaction temperature T_{R} reported in the tables were established in the reactor, and the first pressure pₐ was established within a period tₐ₁. This pressure was held for a period tₐ₂. Subsequently the first pressure pₐ, in accordance with process step b), was lowered to the second pressure p_{b} within a period t_{b}, by distilling off component (D) or (D′) while retaining the reaction temperature T_{R} in the reactor. The second pressure p_{b} and the reaction temperature T_{R} were held, in accordance with process step c), for a period t_{c}. The torque M_{b} of the stirrer after process step b) was measured at a rotary speed of 80 rpm, as was the torque M_{c} of the stirrer after process step c). A portion of the polyamides (P) obtained was removed as a melt from the reactor, cooled in a waterbath, and pelletized. The resulting pellets were extracted with water to remove caprolactam. The other portion of the examples was taken as a melt from the reactor without subsequent pelletization or extraction with water to remove the caprolactam.

The melting temperature T_{M} of the polyamide (P) and also its glass transition temperature T_{G} were determined by means of DSC (differential scanning calometry).

Gel permeation chromatography (GPC; size exclusion chromatography (SEC)) was used to determine the weight-average molecular weight (M_{w}) and the number-average molecular weight (Mₙ) and also the polydispersity (PDI) of the polyamide (P) obtained. Hexafluoroisopropanol (HFIP) was used as solvent.

TABLE 1

| | 17 | 18 | 19 | 20 | 21 | V22 | 23 | V24 | 25 | 26 |
|---|---|---|---|---|---|---|---|---|---|---|
| Components | | | | | | | | | | |
| (A-1) [g] | 262.53 | 318.76 | 160 | 160 | 318.76 | — | 93 | 320 | 384.43 | 358.61 |
| (B-1) [g] | 31.55 | 37.05 | 19.23 | 19.23 | 37.05 | 36.14 | 22.23 | — | 37.05 | 15.36 |
| (B′-1) [g] | — | — | — | — | — | — | 26.57 | — | — | — |
| (B′-2) [g] | — | — | — | — | — | — | 58.4 | — | — | — |
| (C-1) [g] | 34.08 | 42.95 | 20.77 | 20.77 | 42.95 | — | 99.78 | — | — | — |
| (C-2) [g] | — | — | — | — | — | — | — | — | 59.43 | 24.64 |
| (C-3) [g] | — | — | — | — | — | 163.9 | — | — | — | — |
| (B′-C′) [g] | — | — | — | — | — | — | — | 80 | — | |
| (D) [g] | 50 | 200 | 80 | 10 | 10 | — | 60 | 60 | 12 | 6 |
| (D′) [g] | — | — | — | — | — | 500 | — | — | — | — |
| (E) [g] | — | — | — | — | — | — | — | — | — | — |
| Process step a) | | | | | | | | | | |
| T_{A} [° C.] | 220 | 220 | 220 | 220 | 220 | | 220 | 220 | 220 | 220 |
| T_{R} [° C.] | 210 | 210 | 210 | 210 | 210 | | 210 | 210 | 210 | 210 |
| pₐ [bar] | 12.2 | 17 | 15 | 6 | 6.6 | 1 | 8 | 12 | 6.1 | 3.4 |
| tₐ₁ [min] | 25 | 40 | 60 | 60 | 30 | 60 | 30 | 30 | 60 | 30 |
| tₐ₂ [min] | 50 | 40 | 60 | 60 | 60 | 60 | 60 | 60 | 40 | 50 |
| Process step b) | | | | | | | | | | |
| T_{R} [° C.] | 210 | 210 | 210 | 210 | 210 | 210 | 210 | 210 | 210 | 210 |
| p_{b} [bar] | 1 | 1 | 1 | 1 | 1 | 1 | 1 | 1 | 1 | 1 |
| t_{b} [min] | 60 | 60 | 60 | 60 | 60 | 60 | 60 | 60 | 60 | 60 |
| Process step c) | | | | | | | | | | |
| t_{c} [min] | 300 | 60 | 120 | 120 | 60 | 240 | 100 | 90 | 60 | 130 |
| M_{b} | 14 | 14 | 14 | 16 | 21 | | 19 | 17 | 23 | 19 |
| M_{c} | 32 | 14 | 15 | 32 | 60 | | 43 | 60 | 60 | 60 |
| GPC | | | | | | | | | | |
| Mₙ [g/mol] | 13400 | 4700 | 10000 | 18800 | 17600 | 5800 | 15600 | 19100 | 16500 | 19300 |
| M_{w} [g/mol] | 78300 | 15500 | 37400 | 64300 | 46400 | 14100 | 44200 | 44700 | 44100 | 49800 |
| PDI | 5.8 | 3.3 | 3.7 | 3.4 | 2.6 | 2.8 | 2.8 | 2.3 | 2.7 | 2.6 |
| Solvent | HFIP | HFIP | HFIP | HFIP | HFIP | THF | HFIP | HFIP | HFIP | HFIP |
| DSC | | | | | | | | | | |
| T_{M} [° C.] | 196.4 | | | | | 94.7 | 191.5 | 220 | 196.4 | 205.4 |
| T_{G} [° C.] | 52 | | | | | 1 | 73 | 52 | 49 | 52 |

1. A process for preparing a polyamide (P) having a melting temperature T_{M} by polymerization from a reaction mixture (RM) at a reaction temperature T_{R}, wherein the reaction mixture (RM) comprises the following components:
(A) at least one lactam
(B) at least one diamine of the general formula (I) 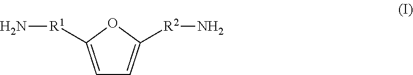
in which
R¹, R² independently of one another are selected from C₁-C₁₀ alkanediyl,
(C) at least one dicarboxylic acid derivative selected from the group consisting of a dicarboxylic acid of the general formula (II), a dicarboxylic ester of the general formula (III), and a dinitrile of the general formula (IV)
HOOC—R³—COOH (II)
R⁵OOC—R⁴—COOR⁶ (III)
NC—R⁷—CN (IV)
in which
R³, R⁴ and R⁷ independently of one another are selected from the group consisting of a bond, unsubstituted or at least monosubstituted C₁-C₄₀ alkanediyl, and unsubstituted or at least monosubstituted C₆-C₄₀ arylene, where
the substituents are selected from the group consisting of F, Cl, Br, I, OR⁸, C₁-C₁₀ alkyl, and C₆-C₁₀ aryl, where
R⁸ is selected from the group consisting of H and C₁-C₁₀ alkyl;
R⁵ and R⁶ independently of one another are selected from the group consisting of unsubstituted or at least monosubstituted C₁-C₂₀ alkyl, unsubstituted or at least monosubstituted C₆-C₂₀ aryl, and unsubstituted or at least monosubstituted C₆-C₂₀ aralkyl, where
the substituents are selected from the group consisting of F, Cl, Br, I, OR⁹, and C₁-C₁₀ alkyl, where
R⁹ is selected from the group consisting of H and C₁-C₁₀ alkyl; and
(D) water.

2. The process according to claim 1, wherein the reaction mixture (RM) is stirred during the polymerization.

3. The process according to claim 1, wherein the reaction temperature T_{R} is above the melting temperature T_{M} of the polyamide (P).

4. The process according to claim 1, wherein the reaction mixture (RM) comprises as component (A) in the range from 26 to 98 wt % of at least one lactam, based on the total weight of components (A) to (D).

5. The process according to claim 1, wherein the reaction temperature T_{R} is in the range from 190 to 235° C.

6. The process according to claim 1, wherein the reaction mixture (RM) comprises as component (D) in the range from 1 to 30 wt % of water, based on the total weight of components (A) to (D).

7. The process according to claim 1, wherein the melting temperature T_{M} of the polyamide (P) is in the range from 80 to 230° C.

8. The process according to claim 1, wherein the reaction mixture (RM) comprises
26 to 98 wt % of component (A),
0.5 to 35 wt % of component (B),
0.5 to 30 wt % of component (C), and
1 to 30 wt % of component (D),
based on the total weight of components (A) to (D).

9. The process according to claim 1, wherein the reaction mixture (RM) comprises a dicarboxylic acid (II) as the at least one dicarboxylic acid derivative (component (C)).

10. The process according to claim 1, wherein the polymerization from the reaction mixture (RM) comprises the following steps:
a) heating the reaction mixture (RM) to a reaction temperature T_{R} and establishing a first pressure pₐ,
b) lowering the first pressure pₐ to a second pressure p_{b} below the first pressure pₐ, the reaction temperature T_{R} from process step a) being retained.

11. The process according to claim 10, wherein the first pressure pₐ in process step a) is in the range from 1 to 25 bar.

12. The process according to claim 10, wherein the second pressure p_{b} in process step b) is in the range from 0.5 to 1.5 bar.

13. The process according to claim 10, wherein step b) is followed by the following step:
c) holding the second pressure p_{b} and the reaction temperature T_{R} from process step b) for a period in the range from 20 minutes to 20 hours.

14. The process according to claim 1, wherein the reaction mixture comprises as component (E) 0.1 to 0.9 wt % of at least one endgroup regulator, based on the total weight of components (A) to (E).
